(19) United States
(12) Patent Application Publication
(10) Pub. No.: US 2018/0092347 A1
(43) Pub. Date: Apr. 5, 2018

(54) INHALATION-BASED REEDLESS WIDGEON DUCK CALL

(71) Applicant: Robert J. Harvey, JR., Bourg, LA (US)

(72) Inventor: Robert J. Harvey, JR., Bourg, LA (US)

(21) Appl. No.: 15/286,544

(22) Filed: Oct. 5, 2016

(51) Int. Cl. A01M 31/00

(52) U.S. Cl. CPC A01M 31/004

(57) ABSTRACT

A duck call device is disclosed for emitting sounds resembling Widgeon duck sounds. The device includes a barrel having an open proximal end configured to make airtight contact with the user's lips, and an open distal end. The device also includes an open resonant chamber sealed circumferentially within the barrel, the open resonant chamber formed by an open convex dome sealed circumferentially to an open concave dome, each dome having a similarly sized central hole in coaxial relationship with the barrel. The open resonant chamber is sized, shaped, and made from a material so as to easily produce a realistic sound of a widgeon duck when a user sucks air in through the barrel. The open resonant chamber is substantially symmetric in that the open convex dome is a mirror reflected version of the open concave dome. The barrel includes a loop for securing a lanyard. No reed is used.

### FIELD OF THE INVENTION

This invention relates generally to duck calls, and particularly to duck calls for attracting widgeon ducks.

### BACKGROUND OF THE INVENTION

A “duck call” is a device crafted and used to simulate the sound of a duck. Early duck calls were simple woodwind instruments having a barrel, a sounding board, and a reed. Duck hunters would make sounds into the duck call, saying “hut”, “wuit”, or “kak”, for example. With the improvement of duck call devices and calling techniques, users of duck calls do not need to use their voice to perform their techniques.

Modern duck calls are either reed-based, or whistle-based, the user simply blowing into the duck call to create a sound that is intended to imitate the sound of a particular type of duck.

In Whistle-based duck calls are adapted to simulate and attract water fowl that make a whistling sound. Both the drake and the hen of some duck species, such as Wood Duck, Pintail, and the American Widgeon, for example, make a whistling sound that can be simulated by a whistle-based duck call device.

However, repeatedly blowing into a whistle-based duck call device causes a buildup of residue (saliva, dust, bacteria, etc) inside the whistle, which becomes unsanitary, and can negatively affect the performance of the device. Consequently, the whistle-based duck call must be cleaned often to remove the residue buildup.

### SUMMARY OF THE INVENTION

A general aspect of the invention is a duck call device for emitting sounds resembling Widgeon duck sounds. The duck call device includes: a barrel having an open proximal end, and an open distal end; and a resonant chamber sealed circumferentially within the barrel, the resonant chamber formed by a proximal convex dome sealed circumferentially to a distal convex dome, each dome having a central hole in coaxial relationship with the barrel, the resonant chamber being configured to produce a sound of a widgeon duck when a user sucks air through the barrel.

In some embodiments, the open proximal end of the barrel is configured to make airtight contact with the user's lips.

In some embodiments, the central hole in each dome is of a substantially similar diameter.

In some embodiments, the resonant chamber is substantially symmetric in that the proximal convex dome is a mirror reflected version of the distal convex dome.

In some embodiments, the proximal convex dome is integral with an inner surface of the barrel.

In some embodiments, the barrel includes a loop for securing a lanyard.

Another general aspect of the invention is a duck call device for emitting sounds resembling Widgeon duck sounds. This duck call device includes: a barrel having an open proximal end, an open distal end, and a proximal convex dome integral with an inner surface of the barrel; and a distal convex concave-dome sealed circumferentially to the proximal convex dome to form an resonant chamber within the barrel, each dome having a central hole in coaxial relationship with the barrel, and the resonant chamber being configured to produce a sound of a widgeon duck when a user sucks air through the barrel.

In some embodiments, the open proximal end of the barrel is configured to make airtight contact with the user's lips.

In some embodiments, the central hole in each dome is of a substantially similar diameter.

In some embodiments, the resonant chamber is substantially symmetric in that the proximal convex dome is a mirror reflected version of the distal convex dome.

In some embodiments, the barrel includes a loop for securing a lanyard.

In some embodiments, the device further includes a vibration-damping ring abutting against the proximal convex dome of the barrel.

Still another general aspect of the invention is a duck call device for emitting sounds resembling Widgeon duck sounds, the device including: a barrel having an open proximal end, an open distal end, and a distal convex dome integral with an inner surface of the barrel; and a proximal convex dome sealed circumferentially to the distal convex dome to form an resonant chamber within the barrel, each dome having a central hole in coaxial relationship with the barrel, and the resonant chamber being configured to produce a sound of a widgeon duck when a user sucks air through the barrel.

In some embodiments, the open proximal end of the barrel is configured to make airtight contact with the user's lips.

In some embodiments, the central hole in each dome is of a substantially similar diameter.

In some embodiments, the resonant chamber is substantially symmetric in that the proximal convex dome is a mirror reflected version of the distal convex dome.

In some embodiments, the barrel includes a loop for securing a lanyard.

In some embodiments, the proximal convex dome is integral with an inner barrel disposed within the barrel.

In some embodiments, the device further includes a vibration-damping ring abutting against the proximal convex dome.

### BRIEF DESCRIPTION OF THE DRAWINGS

Many additional features and advantages will become apparent to those skilled in the art upon reading the following description, when considered in conjunction with the accompanying drawings, wherein:

FIG. 1 is a side view of a user holding the duck call device and pressing his lips against the proximal convex dome and over the inhalation exit hole of the device before inhaling to cause the duck call device to emit sounds resembling duck sounds.

FIG. 2 is a perspective view of the device of FIG. 1, looking into the open distal end of the device, showing the distal convex dome, the inhalation entrance hole and the lanyard connector loop.

FIG. 3 is an exploded perspective view of the device, showing the inner barrel having the proximal convex dome and the inhalation exit hole therein, and the outer barrel having the distal convex dome extending towards the outer barrel's distal end and the inhalation entry hole therein, the outer barrel also having the lanyard connector loop of FIG. 2.

FIG. 4 is a cutaway perspective view showing the proximal convex dome of the inner barrel and the distal convex dome of the outer barrel, together forming a resonant chamber.

FIG. 5 is a cutaway side view showing how the proximal convex dome of the inner barrel joins with the distal convex dome of the outer barrel to form a seam of the resonant chamber of FIG. 4.

FIG. 6 is a close up cutaway side view of the seam of FIG. 5.

FIG. 7A is a cutaway top view of an alternative embodiment showing a barrel having a proximal convex dome, showing exemplary dimensions.

FIG. 7B is a side view showing the alternate embodiment of FIG. 7A, including the lanyard connector loop, showing exemplary dimensions.

FIG. 7C is a rear view of the alternate embodiment of FIG. 7A, showing the inhalation entry hole, and the lanyard connector loop of FIG. 7B

FIG. 8A is a perspective view of a distal convex dome, which is cooperative with the proximal convex dome of FIG. 7A, to in forming a resonant chamber.

FIG. 8B is a side view of the distal convex dome of FIG. 8A, showing exemplary dimensions.

FIG. 8C is a cut-away side view of the distal convex dome of FIG. 8B, showing exemplary dimensions.

FIG. 8D is a rear view of the distal convex dome of FIGS. 8A and 8C, showing an exemplary dimension of the inhalation entry hole of the distal convex dome of FIGS. 8A and 8C.

### DETAILED DESCRIPTION

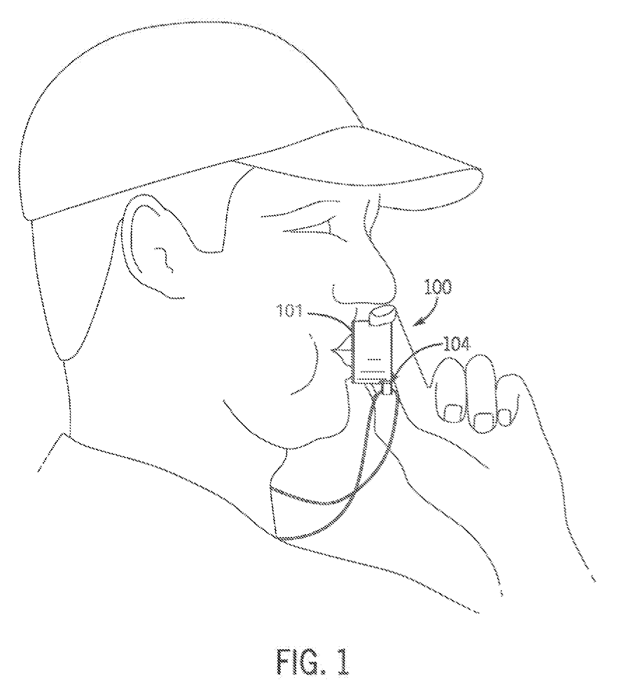

FIG. 1 is a side view of a user holding the duck call device 100 and pressing his lips and mouth against a proximal opening 101 of the device 100 before inhaling to cause the duck call device to emit sounds closely resembling Widgeon duck sounds.

To use the device 100, with the lanyard loop 104 facing away from the user, the user places his lips and mouth over the proximal opening 101 of the device, as shown in FIG. 1. The better the seal with the lips and mouth, the less air is needed to make the device work. The user Inhales with one short breath, one long breath, one short breath, to make a series of sounds like: ho, hoo, ho. The user of the device 100 will soon see ducks appear in response to the sounds.

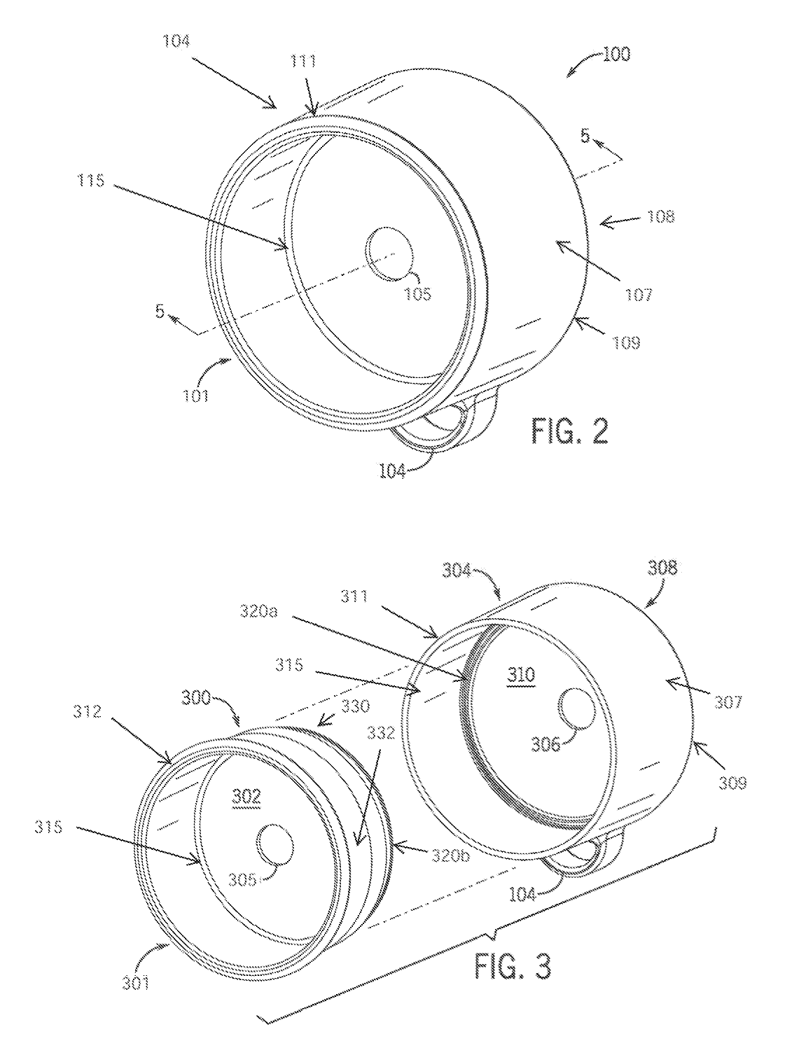

FIG. 2 is a perspective view of the duck call device 100 of FIG. 1, looking into the proximal opening 101 of the device 100, showing the inhalation exit hole 105 and the lanyard connector loop 104. When the user inhales into the device 100, air is sucked through the device, including passing through the inhalation exit hole 105. Device 100 includes a barrel 104, defined by a curved surface 107. The curved surface extends to proximal edge 111 to define a proximal open end 101 of barrel 104, and extends to a distal edge 109 to define a distal open end 108 of barrel 104.

FIG. 3 is an exploded perspective view of one embodiment of the device 100, showing an inner barrel 300. The inner barrel 300 includes a curved surface 332 extending between proximal edge 312 and distal circumferential tab 320b, defining proximal opening 301 and distal opening 330, and has a proximal convex dome 302 disposed therein that extends toward proximal opening 301. In an embodiment, the proximal convex dome 302 is integral with an inner surface of the inner barrel 300. The proximal dome 302 includes an inhalation exit hole 305 concentrically disposed therein.

FIG. 3 also shows an outer barrel 304. The outer barrel 304 includes a curved surface 307 extending between proximal edge 311 and distal edge 309, defining proximal opening 315 and distal opening 308, and has a distal convex dome 310 disposed therein that extends toward distal opening 308. In an embodiment, the distal convex dome 310 is integral with an inner surface of the inner barrel 300. The distal dome 310 includes an inhalation entry hole 306 concentrically disposed therein. The outer barrel 304 also includes the lanyard connector loop 104 of FIG. 2.

To assemble, the inner barrel 300 at the distal opening 330 is inserted into the proximal opening 315 of outer barrel 304, bringing the proximal convex dome 302 into a sealed back-to-back relationship with the distal convex dome 310, thereby forming a resonant chamber therebetween, that is sealed circumferentially within the outer barrel 304. When air is drawn into the device by the user inhaling, air rushes through the inhalation entry hole 306, and then exits through the inhalation exit hole 305, causing air flow instability within the resonant chamber, resulting in resonant vibrations that resemble the sound of a widgeon duck.

The inner barrel 300 and the outer barrel 304, and their respective proximal and distal convex domes 302 and 310, are made from IUPILON S-300UR (a type of Polycarbonate). Materials with similar Young's Modulus (density and stiffness) can also work. This includes many commodity plastics, such as Polycarbonate, ABS, Nylon, Polystyrene, Polyethylene, and Polypropylene.

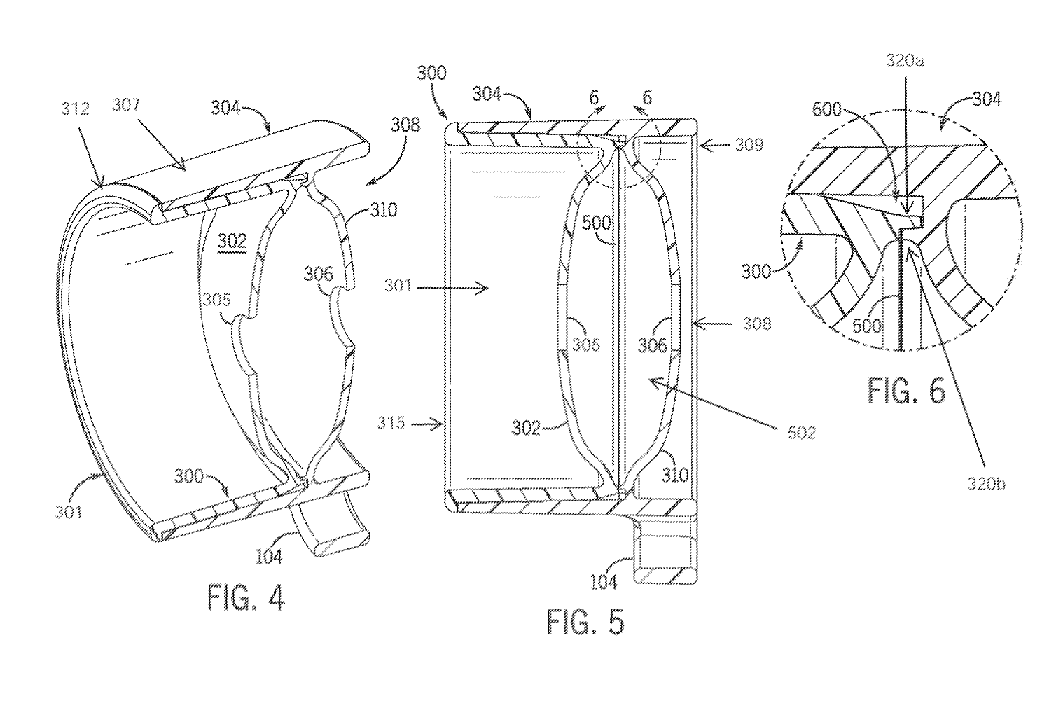

FIG. 4 is a cutaway perspective view showing the proximal convex dome 302 of the inner barrel 300 and the distal convex dome 310 of the outer barrel 304, together forming a resonant chamber 502. FIG. 4 also shows the outer barrel 304 including the inhalation entry hole 306 and distal opening 308. The inhalation entry hole 306 is the round hole in the center of the distal convex dome 310. The outer barrel 304 also includes the lanyard connector loop 104.

FIG. 5 is a cutaway side view showing how the proximal convex dome 302 of the inner barrel 300 joins in a back-to-back relationship with the distal convex dome 310 of the outer barrel 304 to form a seam 500 circumferentially surrounding the resonant chamber 502 of FIG. 4.

FIG. 6 is a close up cutaway side view of the seam 500 of FIG. 5, showing the interlocking 600 circumferential tabs 320a, 320b of the inner barrel 300 and the outer barrel 304, respectively.

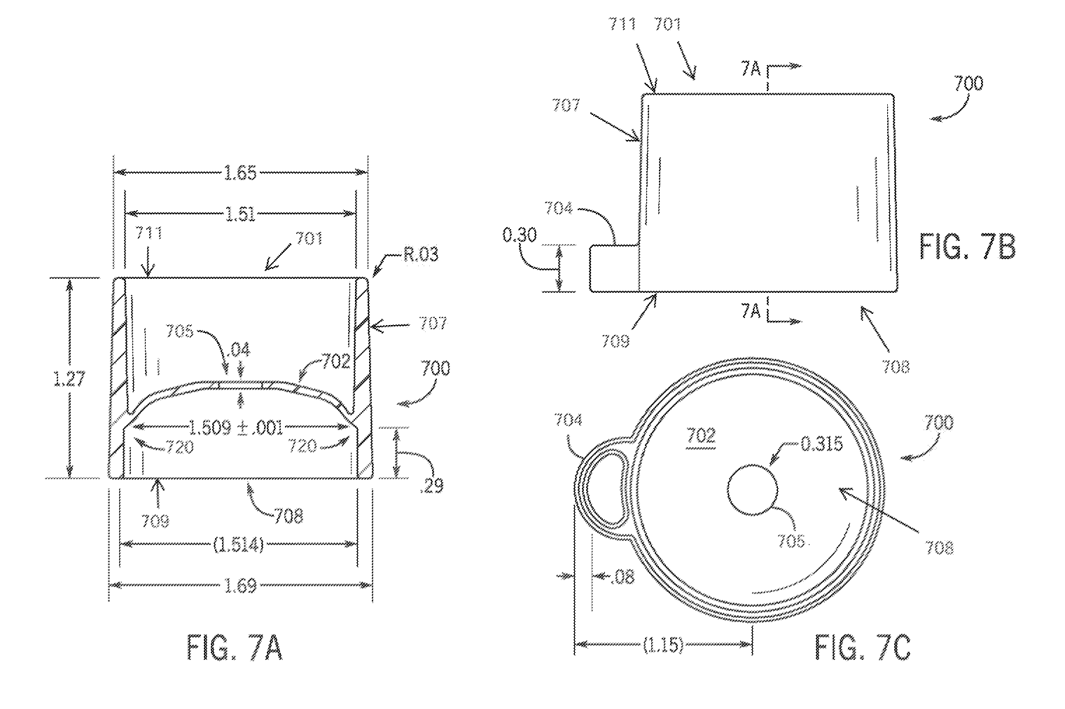

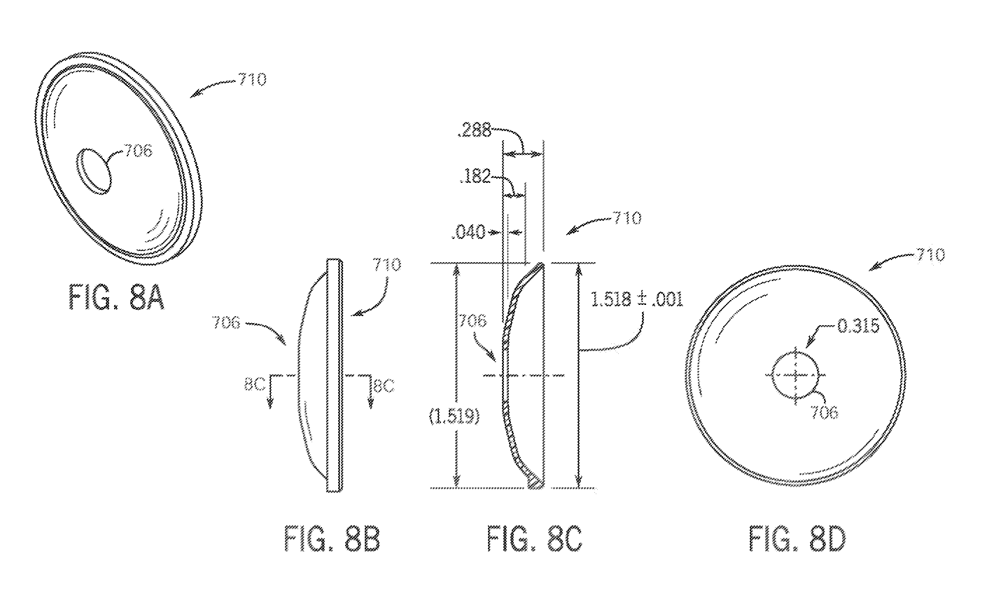

FIG. 7A is a cutaway top view showing exemplary dimensions of a barrel 700 of an alternative embodiment, the barrel 700 having a convex dome 702 extending towards the proximal open end 701, with an inhalation exit hole 705 disposed concentrically therethrough. The barrel 700 also has a distal open end 708, and a circumferential ledge 720 for sealing with a distal convex dome 710 (shown separately in FIGS. 8A-D). When included within the barrel 700, the distal convex dome 710 is oriented in within barrel 700 so that it extends towards the distal open end 708 of the barrel 700 while in a back-to-back arrangement with proximal convex dome 702, with the dial convex dome 700 to form a resonant chamber (not shown), such as the resonant chamber 502 as illustrated in FIG. 5.

In some embodiments, the proximal and distal convex domes are integral with an inner surface of the barrel, including at the circumferential ledge, the location at which the two domes are integrally and sealably coupled to one another circumferentially to form a seam.

FIG. 7B is a side view of the barrel 700 of the alternate embodiment of FIG. 7A, including the lanyard connector loop 706 and its exemplary dimensions. In an embodiment, the two convex domes are identical in dimension as illustrated.

FIG. 7C is a rear view of the barrel 700 looking into the distal open end 708 of barrel 700 without the presence of distal convex dome 710 of the alternate embodiment of FIG. 7A. FIG. 7A shows the inhalation exit hole 705 concentrically located in the proximal convex dome 702, and the lanyard connector loop 704. FIG. 8A is a perspective view of distal convex dome 710, which in this embodiment is typically formed integrally in back-to-back cooperation with the proximal convex dome 702 within the barrel 700, thereby forming the resonant chamber (such as resonant chamber 502 of FIG. 5) when the concave dome 710 is formed with the open distal end 708 of the barrel 700, thereby being integrally secured in a circumferentially sealed relationship with the circumferential ledge 710. As illustrated, the distal convex dome 710 has an inhalation entry hole 706 concentrically disposed therethrough.

FIG. 8B is a side view of the concave dome 710 having the inhalation entry hole 706. If FIG. 8C is a cut-away side view of the concave dome 710 having the inhalation entry hole 706, showing exemplary dimensions.

FIG. 8D is a rear view of the concave dome 710, showing an exemplary dimension of the inhalation entry hole 706.

While a widgeon duck call has been described and illustrated in detail, it is to be understood that numerous modifications can be made to the embodiments of the present invention without departing from the spirit and scope of the invention as claimed.

1. A duck call device for emitting sounds resembling Widgeon duck sounds, the device comprising:
a hollow barrel having a curved surface that extends to a proximal edge defining an open proximal end of the barrel, the curved surface also extending to a distal edge defining an open distal end of the barrel; and
a resonant chamber located within the hollow barrel near its open distal end, the resonant chamber including:
two convex domes joined back-to-back and sealed circumferentially within the barrel, so that a proximal one of the two convex domes extends towards the open proximal end of the barrel, and a distal one of the two convex domes extends toward the open distal end of the barrel;
an inhalation exit hole located concentrically in the proximal convex dome; and
an inhalation entrance hole located concentrically in the distal convex dome,
wherein the resonant chamber is configured to produce the emitted sounds when air is drawn into the inhalation entrance hole and through the resonant chamber by inhaling the air from the inhalation exit hole.

2. The duck call device of claim 1, wherein the proximal convex dome is configured to make airtight contact with a user's mouth via the open proximal end of the barrel prior to inhaling the air.

3. The duck call device of claim 1, wherein the inhalation exit hole is of a substantially similar diameter to the inhalation entrance hole.

4. The duck call device of claim 1, wherein the resonant chamber is substantially symmetrical in that the distal and proximal convex domes are substantially identical in their dimensions.

5. The duck call device of claim 1, wherein the proximal and the distal convex domes are integral with the inner surface of the barrel, and are sealably joined at a circumferential ledge integrally formed with an inner surface of the barrel.

6. The duck call device of claim 1, wherein the distal convex dome is integral with the inner surface of the barrel at the circumferential ledge.

7. The duck call device of claim 1, wherein the curved surface of the barrel includes a loop for securing a lanyard, the loop being located at the distal end of the barrel.

8-10. (canceled)

11. The duck call device of claim 1, wherein an external surface of the distal convex dome resides at about 0.02 inches within the open distal end of the barrel and from the proximal edge of the barrel.

12. The duck call device of claim 1, wherein the circumferential ledge is about 0.29 inches from the distal edge of the barrel.

13. The duck call device of claim 1, further including a vibration damping ring abutting against the proximal edge defining the proximal open end of the barrel.

14. A duck call device for emitting sounds resembling Widgeon duck sounds, the device comprising:
a hollow outer barrel having a curved surface that extends to a proximal edge formed at a proximal end of the outer barrel, and the curved surface extending to a distal edge formed at a distal end of the outer barrel, the outer barrel including a first convex dome extending from a circumferential ledge disposed on an inside surface of the outer barrel toward the proximal end of the outer barrel, the first convex dome having an inhalation exit hole located concentrically with the first convex dome; and
a hollow inner barrel having a curved surface that extends to a proximal edge formed at a proximal end of the inner barrel, and the curved surface extending to a distal edge formed at a distal end of the inner barrel, the inner barrel including a second convex dome extending from the proximal edge of the inner barrel toward the distal end of the inner barrel, the second convex dome having an inhalation entrance hole located concentrically with the second convex dome,
wherein a resonant chamber is formed between the first and second convex domes by inserting the proximal end of the inner barrel completely into the distal end of the outer barrel until the proximal edge of the inner barrel becomes circumferentially sealed against the circumferential ledge to form a seam therebetween, thereby placing the first and second convex domes back-to-back with one another along the seam such that the inhalation entrance and exit holes are coaxial with one other, and
wherein the resonant chamber is configured to produce the emitted sounds when air is drawn through the resonant chamber by way of the inhalation entrance hole, by inhaling the air from the inhalation exit hole.

15. The duck call device of claim 14, wherein the resonant chamber is formed near a proximal end of said duck call device.

16. The duck call device of claim 14, wherein the first convex dome is integral with an inner surface of the barrel at the circumferential ledge.

17-20. (canceled)

21. The duck call device of claim 1, wherein the inhalation exit and entrance holes are in a coaxial relationship with the proximal and distal openings of the barrel and with one another.

22. The duck call device of claim 3, wherein the inhalation entrance and exit holes have a diameter of about 0.315 inches.

23. The duck call device of claim 1, wherein the external surface of the distal convex dome extends to a length that is about 0.692 inches inside the barrel from the distal edge of the barrel.

24. The duck call device of claim 1, wherein the hollow barrel and the proximate and distal convex domes are made from at least one of: polycarbonate, ABS, Nylon, Polystyrene, Polyethylene, and Polypropylene.

25. The duck call device of claim 1, wherein the hollow barrel and the proximate and distal convex domes are made from IUPILON S-300UR or a material having a density and stiffness similar to IUPILON S-300UR.

26. The duck call device of claim 1, wherein the hollow barrel has an inside diameter of about between 1.54 inches at the proximal edge and 1.51 inches at the distal end.

27. The duck call device of claim 1, wherein the hollow barrel has a thickness of about 0.15 inches at the proximal edge and about 0.14 inches at the distal edge.
